(19) United States
(12) Patent Application Publication
(10) Pub. No.: US 2007/0082195 A1
(43) Pub. Date: Apr. 12, 2007

(54) Contrasting tape

(75) Inventors: Thomas R. Goecke, Rocky River, OH (US); Phillip M. Nye JR., Bay Village, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Shieldmark, Inc., Rocky River, OH (US)

(21) Appl. No.: 11/580,634

(22) Filed: Oct. 12, 2006

Related U.S. Application Data
(60) Provisional application No. 60/725,699, filed on Oct. 12, 2005.

(51) Int. Cl. B32B 15/04; B32B 7/12

(52) U.S. Cl. 428/343; 428/354

(57) ABSTRACT

A tape or marking system and method is provided that includes a polymer layer having a plurality of contrasting polymer areas arranged in a side-by-side relationship.

### RELATED APPLICATIONS

This non-provisional application claims the benefit of U.S. Provisional Application No. 60/725,699 filed Oct. 12, 2005 incorporated herein by reference.

### BACKGROUND

The present application relates to the polymer extrusion arts. It finds particular application in the area of floor marking, particularly marking factory floor aisles or other areas and, as such, it will be described with respect thereto. It is to be appreciated, however, that the principles described herein may find additional applicability in a variety of other applications that will occur to those of skill in the art upon learning the teachings here.

In many cases, aisles, lanes and designated areas may be denoted by painted boundaries. Over time the boundaries fade requiring periodic re-painting and associated drying time. At other times, the desired pathways change requiring removal of the old, undesired boundaries and painting of the new boundaries corresponding to the new desired pathway.

As disclosed in U.S. Patent Application no. 2005-0069697, incorporated entirely herein by reference with selected portions incorporated verbatim, adhesive tapes may suitably denote boundaries without some of the disadvantages of a paint system.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example cross-sectional view of a tape.

FIG. 2 illustrates an example cross-sectional view of a tape.

FIG. 3 illustrates an example cross-sectional view of a tape.

FIG. 4 illustrates an example cross-sectional view of a tape.

FIG. 5 illustrates an example tape manufacturing process.

### DETAILED DESCRIPTION

Typical stand-alone luminescent strips have a light colored appearance in full light and do not contrast well with many surrounding floor colors, especially concrete of light colored flooring. Thus, they may not serve well as effective aisle-way markers in normal lighting conditions. However, when a power outage occurs in a normally well lit environment, such luminescent markers may glow for a sufficient period of time to assist building occupants to reach safety or exit the building.

In one use, a floor tape or marking combines colored (including black and white) aisle-way lines with luminescent safety stripe(s) in one aisle-way floor line marker. Because a co-extruded combined aisle-way line marker may have only a small width stripe(s) of luminescent material opposed to a marker made entirely from luminescent material, a significant cost savings is realized because of the comparatively high cost of luminescent resin vis-à-vis PVC resin. With the co-extruded color stripe(s) and luminescent stripe(s) combined into one aisle-way marker line, users can choose aisle-way floor line marker colors that contrast with their existing floor colors and have the added safety benefit of glow-in-the-dark functionality with only one aisle-way floor line marker.

A tape or marker may be made by co-extruding PVC resins with luminescent resins into a floor line marker in various thicknesses and in various widths. A double faced tape with a white or other reflective medium may be attached to a bottom side of the floor line marker. The bleached white tape medium reflects more light onto luminescent surface material and more fully charges the luminescent material. A more fully charged luminescent material may assist the marker in glowing more brightly and/or more persistently.

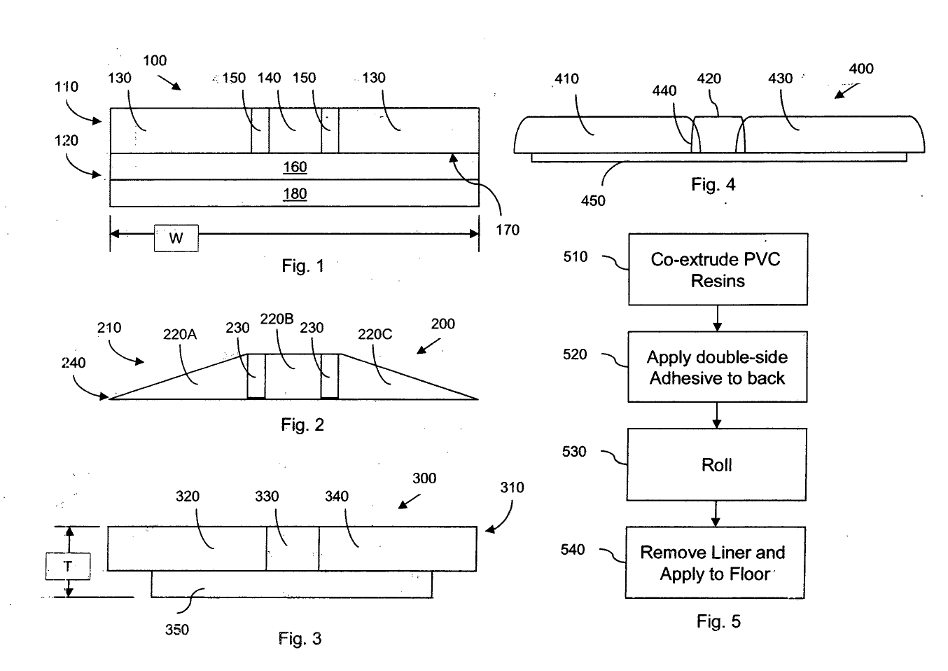

With reference now to FIG. 1, an exemplary tape 100 may include an exposed layer 110, and an adhesive layer 120. The exposed layer 110, may further include a first polymer 130, and a second polymer 140. In one embodiment, the first polymer 130 and the second polymer 140 comprise co-extruded polyvinyl chloride resins of contrasting color. Other resins suitable for co-extrusion may be substituted. In another embodiment, one of the first polymer layer 130 and the second polymer layer 140 comprises a photoluminescent polymer. The co-extrusion process may bind or join the polymer layers together, for example by fusing the contrasting resins in an interface area 150. As an example, the interface area 150 may be small enough to be virtually undetectable by unaided human vision. The exposed layer 110 may be virtually any width W. Exemplary widths include 1 inch through 4 inches (2.5-10.0 cm) although smaller or greater widths may be employed.

They adhesive layer 120 may further include an adhesive 160 adhered to a back 170 of the exposed layer 110. After manufacture and during shipping and storage, the adhesive 160 may be protected by a backing film or layer 180 removable prior to applying the tape 100 to a working surface, such as a warehouse floor. Alternatively, the adhesive may be applied directly to the back 170 of the exposed layer 110 immediately prior to installation. In yet another alternative, the adhesive may be applied to the desired surface, such as a wall, prior to application of the exposed layer 110 .

With reference now to FIG. 2, an exemplary tape 200 may include an exposed layer 210. The exposed layer 210, may further include first polymer segments 220A-C, and second polymer segments 230. As can be seen, portions of the first polymer segments 220A-C may be tapered, angled, or otherwise shaped to diminish the likelihood that the tape may be caught, pulled, or interfered with by an object meeting the tape 200, for example, at an edge 240 where the tape may lie adjacent to a floor or surface on which the tape 200 may be positioned. It is appreciated that the angle may be varied to meet particular circumstances or desires and that there is no particular need for the angle to be uniform or continuous from the second polymer 230 to the surface as illustrated. Moreover, it may be advantageous in some uses to have different polymers, perhaps of different contrast, colors or materials, for each or any of individual first polymer segments 220A-C.

With reference now to FIG. 3, an exemplary tape 300 may include an exposed layer 310. The exposed layer 310, may further include first segment 320, a second segment 330, and a third segment 340. The segments may each comprise similar or different polymer materials or, in an alternate embodiment, selected segments may comprise other materials. As an example, the second segment 330 may comprise an LED strip or other preformed material joined with other segments during or following the extrusion process, or a segment may include reflective material. The tape 300 may also include an adhesive material 350 to adhere the exposed layer 310 to a desired surface (not shown). As can be seen, the adhesive material 350 need not extend to the outer edge or perimeter of the exposed layer 310. This arrangement may be used, for example, where it is desirable for the outermost edges of the exposed material to angle slightly to contact the surface on which the tape 300 is placed. In other words, the applied tape 300 may have a smaller thickness at the peripheral edges where surface contact is made and a greater thickness of at least the adhesive material 350 than in the middle. In the illustrated embodiment, the tape 300 may comprise a maximum thickness T suitable for the desired application. For example, where the exposed layer 310 comprises contrasting or similar polymer layers, and is intended for a flooring environment, it may preferably have a thickness between 0.020 and 0.065 inches (0.05-0.17 cm).

With reference now to FIG. 4, an exemplary cross section of marker 400 may include multiple exposed sections 410, 420, and 430 arranged together. In one embodiment, the sections 410, 420, and 430 may be joined together by a co-extrusion process during manufacture or sections 410, 420, and 430 may be joined by arranging discrete portions on a substrate (not shown). As shown in the illustrated embodiment, the sections 410, 420, and 430 may comprise at least one visually distinct section jointed with others during a co-extrusion process where the sections integrate to form a combined unified arrangement. In one embodiment, integration occurs where originally distinct materials interact in a transition area 440. The marker 400 may further include a double sided tape 450 where a first side is affixed to an underside of the exposed sections 410, 420, and 430, and a second opposed side is arranged for affixation to the desired surface.

With reference now to FIG. 5, an exemplary method of manufacturing a marker or tape is shown. In one embodiment, polyvinyl chloride resins may be co-extruded to form a coherent exposed surface comprising multiple sections, step 510. In some embodiments, the multiple sections include sections visually distinct from other sections, and in other embodiments, the multiple sections include sections visually distinct from the surface onto which the exposed surface is to be placed. In yet other embodiments, polyvinyl chloride resins may be extruded with at least one section of photoluminescent resin. In other embodiments, resins may be extruded with at least one section of lighting material, such as an LED strip. An adhesive may then be applied, step 520, such as a double-sided adhesive to a back or non-exposed side of the exposed surface. As the complete tape is assembled, the tape and adhesive combination may be rolled for convenient storage or transport, step 530. At a desired marking location, the assembly may be positioned and a liner may be removed from the adhesive, step 540 to facilitate adhesion of the tape at the desired marking location.

Other examples of the pressure-sensitive adhesive tape include a layer of polymeric material is attached to the top side of a layer of pressure-sensitive adhesive material and a laminating substrate is attached to the bottom side of the pressure-sensitive adhesive material. Upon removal of the laminating substrate, the tape can be applied to a floor with the application of pressure.

The pressure-sensitive adhesive tape of this invention can be produced in a variety of lengths, widths, and thickness. A variety of colors can also be used for the outer surface of the layer of polymeric material. For example, safety yellow can be used for aisle markings, or red can be used for quarantine and reject markings in a production facility. Coloring can be achieved by introducing a colorant in any form, including pigments and dyes into the polymeric material.

The adhesive employed in layer material may be any of those heretofore employed in the art for preparing adhesive structures. By way of illustration, suitable adhesives of this general description include those disclosed in U.S. Pat. No. 5,061,559, herein incorporated by reference.

The layer of polymeric material may be a durable polymer such as polyvinyl chloride, polycarbonate, or a terpolymer comprised of acrylonitrile, butadiene and styrene or the like. A clear or tinted polyvinyl chloride is a preferred material. The polymer selected may have Shore A Hardness between, for example, 92-100, and preferably between 93-97. The outer surface of the layer of polymeric material (1) is preferably textured. The layer of polymeric material (1) may have a thickness of about, for example, 0.020″ to 0.065″.

Advantageously, this embodiment provides improved tear resistance, strength, and abrasion resistance by employing the sum or all of the combination of polymer selected, Shore A Hardness, textured surface, and layer thickness.

### EXAMPLES

Embodiments of the invention will be described below in greater detail through the following examples.

Test samples were performed on a 4″ wide sample of the pressure sensitive adhesive tape of this invention. The example tape was constructed of a semi-rigid 95A polyvinyl chloride from Artemis Industries, 2550 Gilcrest Rd, Akron Ohio 44305 which was extruded from a 2&½″ diameter NRM extrusion machine at 360-380.degree. F. at an extrusion rate of 400 ft per hour to yield a 0.065 thick, 4″ wide layer. A textured first surface of the extruded polymer layer was achieved by following the above process parameters. During extrusion a rubberized double sided carpet tape (Product # 591B) from International Tape Co., P.O. Box 240, 6 Industrial Drive, Windham, N.H. 03087 was applied to a second side of the extruded polymer layer. A tape from Windmill Tapes of Great Britain (www.windmilltapes.com) was used for comparison purposes. Test samples were conditioned at 73.+−0.3.degree. F. and 50.+−0.5% relative humidity for at least 24 hours prior to testing.

Tensile strength at yield point was determined according to ASTM D 882 testing method. A 0.5″. times.8″ sample was prepared and placed in the jaws of the instrument at a separation of 4.0″. The tester was started at a separation rate of 2.0 in/min. At the instance the tape yielded the force was recorded. Five replicates of each sample were conducted and the results were normalized to pounds per inch width. Results indicate higher yield point and higher absolute forces involved at yield point for the pressure sensitive adhesive tape of this invention. Particularly, the yield point in both machine and traverse direction were respectively, on average, 3,176 lb/in.sup.2 and 3,136 lb/in.sup.2.

Tear resistance was determined according to the ASTM D 1004 test method. The samples were die cut according to the method. The liner from the sample was removed and the sample was placed in the jaws of the tester at a separation of one inch. The tester was started at a rate of 2.0 in/min. The maximum force encountered during testing was recorded. Five replicates of each sample in both the machine and traverse direction were tested. Results indicate substantially improved tear strength in both the machine and traverse directions for the pressure sensitive adhesive tape of this invention. Particularly, the tear strength in both machine and traverse direction was respectively, on average, 22.3 lb and 22.1 lb.

Caliper or thickness was determined according to the PSTC-33 method. Caliper of the material was determined both with and without the liner. Ten replicates of each sample were measured. Results indicate substantially increased thickness of the pressure sensitive adhesive tape of this invention, partly because of the inherent characteristics of the semi-rigid surface. Particularly, the thickness of the material, with and without the liner, was respectively, on average, 68.4 mil and 65.4 mil.

Peel adhesion was tested according to a modified PSTC-101D method. The modification included dwell time. Peel adhesion is a measure of the strength of the adhesive bond between the tape and the test surface. Exactly one (1.0) inch wide samples were applied to a standard stainless steel test panel at a rate of 24 in/min with a 4.5 pound rubber covered roller according to the method. The tape was then peeled from the substrate at a 90.degree. angle after a dwell time of one hour. The force required for removal was measured. Five replicates of each sample were tested. Results indicate substantially increased peel adhesion for the pressure sensitive adhesive tape of this invention when applied to stainless steel. Particularly, the peel adhesion of this material was, on average, 5.2 lb/in width.

Abrasion resistance was determined according to a modified ASTM D 5264 test method. The material was cut to a 2.5″.times.6″ size. A new 2″.times.4″ piece of standard A-5 receptor material (moderate abrasive) from Gavarti Associates Ltd. was affixed with double-sided tape to the four pound instrument weight (0.5 lb/in 2 load). This in turn was placed over the test sample. The instrument was set for 100 strokes and operation was initiated. The instrument strikes an arc with the abrasive over the test material. Each stroke consists of one motion back and forth over the sample. When the cycles were completed the weighted abrasive was lifted and the test sample removed. At the conclusion of the test the overall quality of each sample was evaluated relatively for scratch resistance. Results indicate that the abrasion resistance of the pressure sensitive adhesive tape of this invention is improved over the comparative tape.

| | | |
|---|---|---|
| | σ | |
| | (standard | N (test |
| Average | deviation) | numbers) |

Tensile at Yield at 2.0 in/min, lb/in²

| | | | |
|---|---|---|---|
| Inventive Sample Machine Direction | 3,176 | 152 | 5 |
| Inventive Sample Traverse Direction | 3,136 | 56 | 5 |
| Comparative Sample Machine Direction | 2,400 | 160 | 5 |
| Comparative Sample Transverse | 1,720 | 120 | 5 |
| Direction | | | |

Tear at 2.0 in/min, lb.

| | | | |
|---|---|---|---|
| Inventive Sample Machine Direction | 22.3 | 1.6 | 5 |
| Inventive Sample Traverse Direction | 2.2 | 0.1 | 5 |
| Comparative Sample Transverse | 1.6 | 0.1 | 5 |
| Direction | | | |

Caliper, mil.

| | | | |
|---|---|---|---|
| Inventive Sample With Line | 68.4 | 0.5 | 10 |
| Inventive Sample Without Liner | 65.4 | 0.5 | 10 |
| Comparative Sample | 5.5 | 0.04 | 10 |
| Adhesion to Stainless lb/in width | | | |
| Inventive Sample | 5.2 | 0.5 | 5 |
| Comparative Sample | 1.7 | 0.03 | 5 |

Abrasion Resistance

| | |
|---|---|
| Inventive Sample | Excellent - no sign of damage |
| Comparative Sample | Fair - moderate damage |

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both.” When the applicants intend to indicate “only A or B but no both” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See, Bryan A. Gamer, A Dictionary of Modem Legal usage 624 (2d. Ed. 1995).

What is claimed is:

1. An article of manufacture comprising:
A thermoplastic polymer layer defining two opposing sides,
where a first side includes a relatively planar bottom surface configured to be supportably connected to a substrate and
where an opposing second side includes at least two visually distinguishable discrete areas disposed in a side-by-side relationship together forming a top surface substantially parallel to the bottom surface.

2. The article of manufacture as set forth in claim 1, further comprising an adhesive layer applied at least along a central axis of the relatively planar bottom surface and but not extending to outer edge areas parallel to and offset from the central axis.

3. The article of manufacture as set forth in claim 1, where the thermoplastic polymer layer has a thickness at an outer edge area parallel to a central axis that is less than a thickness along the central axis.

4. The article of manufacture as set forth in claim 1, further comprising an interface area between the at least two visually distinguishable discrete areas where polymers constituting the at least two visually distinguishable areas are bonded.

5. The article of manufacture as set forth in claim 1, where at least one of the visually distinguishable areas comprises a photoluminescent polymer.

6. The article of manufacture as set forth in claim 1, where the visually distinguishable areas comprise contrasting colored polymers.

7. The article of manufacture as set forth in claim 1, further comprising a double sided tape adhesive adhered to the relatively planar bottom surface.

8. The article of manufactuer as set forth in claim 7, where the double sided tape comprises a light reflective material.

9. An adhesive marker comprising:
an adhesive layer; and
an exposed layer having at least two polymeric segments, including at least a first polymeric segment and a second polymeric segment, wherein the first polymeric segment is visually distinct from the second polymeric segment and a top surface of each of the at least two polymeric segments is exposed.

10. The adhesive marker of claim 9, wherein at least one of the at least two polymeric segments is constructed of a photoluminescent polymer.

11. The adhesive marker of claim 9, wherein the at least two polymeric segments are co-extruded.

12. The adhesive marker of claim 9, wherein the at least two polymeric segments includes at least a third polymeric segment.

13. The adhesive marker of claim 12, wherein the third polymeric segment has substantially the same appearance as the first polymeric segment.

14. The adhesive marker of claim 12, wherein the third polymeric segment is visually distinct from each of the first polymeric segment and the second polymeric segment.

15. The adhesive marker of claim 9, further comprising a backing film.

16. The adhesive marker of claim 9, where the exposed layer comprises a thickness between 0.020 and 0.065 inches.

17. A method of making visually contrasting floor markings comprising:
providing a first plastic resin;
providing a second plastic resin visually distinguishable from the first plastic resin;
substantially simultaneously urging the first plastic resin and the second plastic resin through a co-extrusion mold in a side-by-side arrangement such that the first resin and the second resin bond together along a side to form a unitary layer;
applying an adhesive to affix a substantially planar surface of the unitary layer to a floor; and
instructing a user to apply the unitary layer to the floor such that the adhesive joins the unitary layer and floor.
